(19) United States
(12) Patent Application Publication
(10) Pub. No.: US 2013/0283341 A1
(43) Pub. Date: Oct. 24, 2013

(54) METHOD OF SECURING A MOBILE TERMINAL

(71) Applicants: Hyoung-Bae Park, Seoul (KR); Jeong-Ah Kim, Seoul (KR); Kyu-Min Choi, Seoul (KR); Yun-Seok Lee, Seoul (KR); Sung-Goo Kim, Seoul (KR)

(72) Inventors: Hyoung-Bae Park, Seoul (KR); Jeong-Ah Kim, Seoul (KR); Kyu-Min Choi, Seoul (KR); Yun-Seok Lee, Seoul (KR); Sung-Goo Kim, Seoul (KR)

(73) Assignee: PLUSTECH INC., Seoul (KR)

(21) Appl. No.: 13/883,161

(22) PCT Filed: Nov. 2, 2011
(86) PCT No.: PCT/KR11/08311

§ 371 Date: Jul. 10, 2013

(30) Foreign Application Priority Data
Nov. 2, 2010 (KR) 10-2010-0108303

(51) Int. Cl. H04L 29/06

(52) U.S. Cl. CPC H04L 63/20
USPC 726/1

(57) ABSTRACT

The present invention relates to a method of implementing a security system for preemptively preventing a decrease in work efficiency due to leaked confidential secrets or the browsing of non work-related sites through a mobile terminal. A security manager implements an environment for allowing, blocking, or recording Internet usage in an independent mobile communication network in an area requiring security, uses a security system server to preregister information on mobile terminals of users who are expected to use the Internet, makes agreements on how personal information will be handled when outside visitors visit the network, registers information on mobile terminals of outside visitors with the security system server, and oversees the installation of a security app whenever necessary.

### TECHNICAL FIELD

The present invention relates to a method of processing Internet usage security of a mobile terminal apparatus using a mobile communication network in an area requiring security, or a workplace, and more particularly, to a method of blocking use of the Internet or recording a usage history when a user uses the Internet through a mobile terminal apparatus, by enforcing an advance registration procedure for use of the Internet on a visitor or an employee entering an area requiring security for registering information about the user, information about the mobile terminal apparatus, for example, a media access control (MAC) address, and a phone number, and the like.

In addition, a security app may be installed in the mobile terminal apparatus, as necessary, in order to enhance security. When the user uses the internet through the mobile terminal apparatus in the area requiring security, an access to the Internet may be blocked or a usage history may be recorded. When the mobile terminal apparatus leaves the area, such restrictions on use of the internet may be lifted.

In particular, the present invention relates to a method of securing a mobile terminal apparatus in a limited area requiring security, such as a workplace, the method including (a) a basic information registration operation of inputting information about a user and information about a mobile terminal apparatus into a security system server, (b) a privacy policy agreement operation of notifying the security system server of information regarding whether an agreement on collection of traffic related to security and Internet blocking is obtained in advance, (c) a blocking policy transmission operation of transmitting, by the security system server, a blocking policy to a blocking server, (d) a blocking application operation of allowing or blocking, by the blocking server, an access of the mobile terminal apparatus to the Internet, and (e) a blocking discontinuation operation of notifying, by the security system server, the mobile terminal apparatus of discontinuation of the blocking policy.

### BACKGROUND ART

In general, the Internet has been used in workplaces in a wired manner, rather than a wireless manner and thus, management of a corresponding wired network may be sufficient for in-house network security. However, with a remarkable increase in use of a wireless Internet, for example, third generation (3G) wireless Internet, wireless broadband Internet (WiBro), and the like, through a mobile terminal apparatus, tracking of in-house confidential data being leaked through a wireless Internet access may be difficult. In addition, work efficiency may decrease when an employee accesses non-work related sites, and the like.

In order to overcome such weaknesses in security, an application (app) configured to prevent use of the wireless Internet may be installed in a mobile terminal apparatus, or an employee may be requested to surrender a mobile phone when entering a workplace, and retrieve the mobile phone when leaving the workplace. However, although such an app is installed, management of the app may be difficult. In addition, when an audio data frequency is used to access the Internet, blocking the Internet access may be impossible. When use of a mobile terminal apparatus is banned, an employee may experience an inconvenience of making a call for an urgent case. Accordingly, normal application of a security system may be difficult.

In particular, with a recent propagation of smart phones, a number of tasks may be performed through a mobile terminal apparatus. Recording, video making, photo taking, accessing the Internet, and the like may be performed through the mobile terminal apparatus. When information is leaked, serious damage may be caused and tracking a leak may be impossible. Accordingly, in reality, prevention of the foregoing issues may be difficult.

### DISCLOSURE OF INVENTION

### Technical Goals

In order to resolve the issues described above, an aspect of the present invention provides a method of securing a mobile terminal apparatus that may increase work efficiency by internally protecting in-house confidential information and restricting an access to a non-work related site. In particular, a security manager may construct an in-house security system, and apply a security procedure for usage of a mobile terminal apparatus to an outside visitor or an employee visiting a workplace. When the outside visitor or the employee wishes to use the mobile terminal apparatus, an agreement of the user to a privacy policy may be obtained, and personal information, information about a mobile phone, and the like may be recorded with a security system server. In addition, by installing an app in the mobile terminal apparatus, as necessary, limited use of the Internet may be allowed and a corresponding usage history may be recorded.

According to an aspect of the present invention, there is provided a method of securing a mobile terminal apparatus in a limited area requiring security, such as a workplace, the method including (a) a basic information registration operation of inputting information about a user and information about a mobile terminal apparatus into a security system server, (b) a private policy agreement operation of notifying the security system server of information regarding whether an agreement on collection of traffic related to security and Internet blocking is obtained in advance, (c) a blocking policy transmission operation of transmitting, by the security system server, a blocking policy to a blocking server, (d) a blocking application operation of allowing or blocking, by the blocking server, an access of the mobile terminal apparatus to the Internet, and (e) a blocking discontinuation operation of notifying, by the security system server, the mobile terminal apparatus of discontinuation of the blocking policy.

However, technical goals of the present invention are not to be limited to the foregoing goals, but rather may include other goals not yet mentioned herein. Such goals may be readily understood by those skilled in the art from the following description.

### Technical Solutions

According to an aspect of the present invention, there is provided a method including a basic information registration operation of constructing an environment for capturing all Internet usage packets of a mobile terminal apparatus and preregistering information to be used for a security system with respect to a user expected to use the Internet through the mobile terminal apparatus in an area requiring security, a privacy policy agreement operation of temporarily registering a user in a security system server due to an unexpected visit and receiving an agreement to collection of a usage history, a blocking policy transmission operation of transmitting, by the security system server, a blocking policy to a blocking server, a blocking application operation of allowing and blocking an access to the Internet, uploading a specific file, an access to a non-work related site, and the like in the area requiring security to which a policy adopted by the security system server applies, and a blocking discontinuation operation of reporting discontinuation of the blocking policy to the user when a security manager confirms the discontinuation of the blocking policy or when the mobile terminal apparatus moves away from the area requiring security.

In the construction of the environment, the area requiring security may be constructed using a femtocell in response to a request from the security manager in order to fundamentally block use of a mobile communication network, except a registered mobile terminal apparatus.

In the blocking application operation, in a case of an outside visitor, a short message service (SMS) may be transmitted to a mobile terminal apparatus of the outside visitor or the outside visitor may be guided to recognize a quick response (QR) code in response to a request from the security manager, and a security app installation site linked to a uniform resource locator (URL) displayed on the mobile terminal apparatus of the user may be accessed to install a security app in the mobile terminal apparatus.

In the privacy policy agreement operation, when the user corresponds to an employee, the agreement may be obtained by transmitting a URL linked to a privacy policy agreement webpage using an SMS or an input of the agreement may be received by transmitting a privacy policy agreement authentication code using an SMS since the employee is already identified. The privacy policy agreement operation may be performed by a written form registration method of receiving, by the security manager, a privacy policy agreement signature directly from the employee and transmitting a result using an SMS. When the user corresponds to an outside visitor, the privacy policy agreement operation may be performed for a user completing a procedure for identifying the user, wherein the procedure may include copying an ID card, registering a photo and a signature of the outside visitor, and the like.

In the blocking application operation, by interworking with a subscriber authentication system of a mobile communication provider, information of a mobile terminal apparatus of a subscriber may be compared to information of a mobile terminal apparatus currently using the Internet in an area to which security is currently being applied, and security corresponding to non-work related site blocking, upload restrictions, Internet blocking, and the like may be applied based on a policy when the pieces of information correspond to each other.

In the blocking discontinuation operation, when the mobile terminal apparatus leaves the area to which the blocking policy applies, discontinuation of blocking may be reported to the user, the blocking may be discontinued, and the security app may be uninstalled, or the blocking may be discontinued by inputting a blocking discontinuation command of the security manager into the security system server according to a blocking discontinuation procedure or by recognizing a QR code, and the security app may be uninstalled.

### Advantageous Effects of the Invention

According to an embodiment of the present invention, it is possible to provide a system for blocking use of a mobile communication network and wireless Internet, aside from a user registered with a security system server in an area requiring security.

Accordingly, by recording, using a mobile terminal apparatus, a history of Internet usage for an access to a non-work related site, leakage of confidential information, and the like, or by performing upload restrictions, Internet blocking, and the like, it is possible to prevent issues, for example, leakage of important data, a decrease in work efficiency, and the like. It is also possible to produce an effect of tracking a user of a mobile terminal apparatus when the foregoing issues occur.

### BRIEF DESCRIPTION OF DRAWINGS

FIG. 1 is a diagram illustrating construction of an environment for filtering or mirroring an Internet usage packet of a mobile terminal apparatus using the Internet through various types of networks.

FIG. 2 is a diagram illustrating a security manager inputting personal information of a user expected to use the Internet, information about a mobile terminal apparatus, and an agreement to a privacy policy into a security system server.

FIG. 3 is a diagram illustrating a security manager inputting personal information of a user, for example, an outside visitor, who has to use the Internet unexpectedly, information about a mobile terminal apparatus, and an agreement to a privacy policy into a security system server.

FIG. 4 is a diagram illustrating a process of performing Internet blocking when a user having a mobile terminal apparatus without an app installed uses the Internet.

FIG. 5 is a diagram illustrating a process of performing Internet blocking when a user having a mobile terminal apparatus with an app installed uses the Internet.

FIG. 6 is a diagram illustrating a process of discontinuing Internet blocking when a user having a mobile terminal apparatus without an app installed receives a blocking discontinuation command from a security manager or leaves a blocking area.

FIG. 7 is a diagram illustrating a process of discontinuing Internet blocking when a user having a mobile terminal apparatus with an app installed receives a blocking discontinuation command from a security manager or leaves a blocking area.

### BEST MODE FOR CARRYING OUT THE INVENTION

Herein, there is provided a method of securing a mobile terminal apparatus in a limited area requiring security, such as a workplace, the method including a basic information registration operation of inputting information about a user and information about a mobile terminal apparatus into a security system server, a privacy policy agreement operation of notifying the security system server of information regarding whether an agreement on collection of traffic related to security and Internet blocking is obtained in advance, a blocking policy transmission operation of transmitting, by the security system server, a blocking policy to a blocking server, a blocking application operation of allowing or blocking, by the blocking server, an access of the mobile terminal apparatus to the Internet, and a blocking discontinuation operation of notifying, by the security system server, the mobile terminal apparatus of discontinuation of the blocking policy.

### MODE FOR CARRYING OUT THE INVENTION

Hereinafter, exemplary embodiments of the present invention will be described in detail with reference to the accompanying drawings so that those skilled in the art can readily carry out the invention.

The present invention is not limited to the embodiments described herein, and may be implemented in several different forms. Portions unrelated to the description will be omitted to clearly describe the present invention in the drawings.

When a part “comprises (includes)” an element, unless described to the contrary, it should be understood that the part may further comprise (include), rather than exclude, other elements.

Throughout the specification of the present invention, the expression “operation of” does not mean “operation for”.

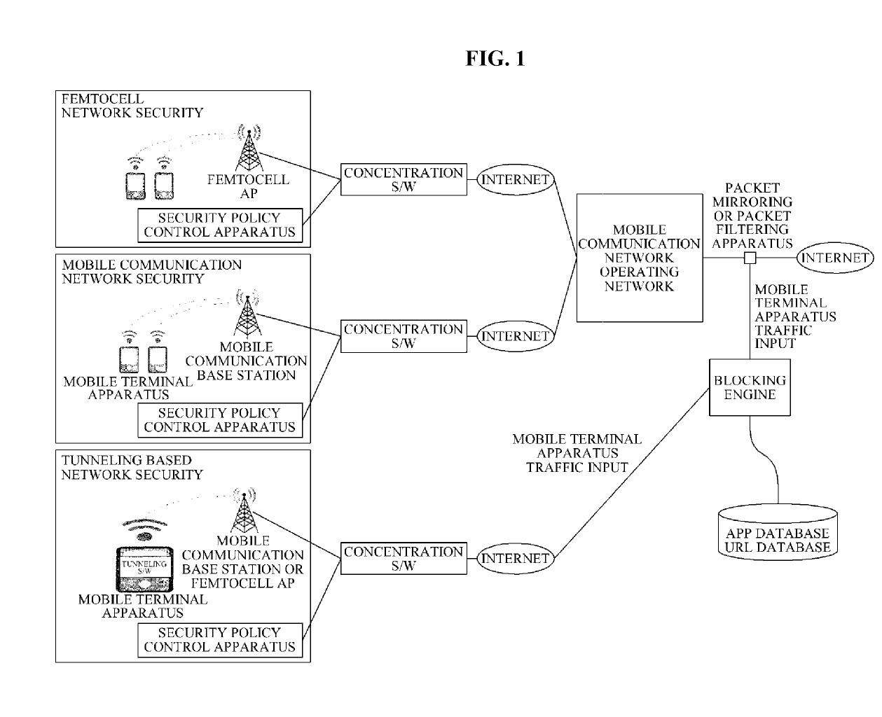

Hereinafter, a method of securing a mobile terminal apparatus will be described in detail with reference to FIGS. 1 through 7.

According to an aspect of the present invention, there is provided a method of securing a mobile terminal apparatus in a limited area requiring security, such as a workplace, the method including (a) a basic information registration operation of inputting information about a user and information about a mobile terminal apparatus into a security system server, (b) a privacy policy agreement operation of notifying the security system server of information regarding whether an agreement on collection of traffic related to security and Internet blocking is obtained in advance, (c) a blocking policy transmission operation of transmitting, by the security system server, a blocking policy to a blocking server, (d) a blocking application operation of allowing or blocking, by the blocking server, an access of the mobile terminal apparatus to the Internet, and (e) a blocking discontinuation operation of notifying, by the security system server, the mobile terminal apparatus of discontinuation of the blocking policy.

In an exemplary embodiment, the method may further include a packet transmission operation of transmitting, to the blocking server, a packet input into packet mirroring or packet filtering equipment installed between a base station and the blocking server, when the mobile terminal apparatus accesses the Internet through the base station. However, the embodiment is not limited thereto.

In an exemplary embodiment, the method may further include a tunneling operation of tunneling, to the blocking server, a packet used by the mobile terminal apparatus, through software installed in the mobile terminal apparatus to support tunneling, when the mobile terminal apparatus accesses the Internet through a base station. However, the embodiment is not limited thereto.

In an exemplary embodiment, the base station may include a femtocell access point (AP), or a mobile communication base station. However, the embodiment is not limited thereto.

FIG. 1 is a diagram illustrating various examples of construction of an environment for filtering or mirroring an Internet usage packet of a mobile terminal apparatus.

As shown in FIG. 1, on a femtocell network, a tunneling based network, and a mobile communication network requiring security, a security manager may construct an environment for filtering or mirroring a packet of an Internet communication section provided by a mobile communication network provider. A blocking server may receive traffic input through concentration switches from a security system server. The blocking server may perform Internet blocking, upload restrictions, and an access of a mobile terminal apparatus to a non-work related site, based on a blocking policy.

Here, the tunneling based network may employ a scheme of installing tunneling software in the mobile terminal apparatus and performing communication directly with the blocking server using a tunneling scheme. The tunneling based network may support various schemes, for example, generic routing encapsulation (GRE), level-2 tunnel protocol (L2TP), point-to-point tunnel protocol (PPTP), and the like.

The femtocell network may be constructed such that a closed femtocell may be installed in an area requiring security, a mobile terminal apparatus may be registered, and the registered mobile terminal apparatus may access the Internet using only the femtocell when entering the area requiring security.

When traffic is input by a packet filtering scheme, the internet blocking may be performed by an upstream blocking scheme of preventing a packet of a target of Internet blocking to be uploaded through the Internet. When the traffic is input by a packet mirroring scheme, the internet blocking may be performed by a scheme, for example, transmission control protocol (TCP) hijacking.

In an exemplary embodiment, the basic information registration operation may be performed by a method of inputting, into the security system server directly by a security manager, the information about the user and the information about the mobile terminal apparatus, or a method of installing, by the mobile terminal apparatus, a security app (a mobile terminal security program), when the security system server transmits a uniform resource locator (URL) or an authentication code to the mobile terminal apparatus, using a short message service (SMS) or a quick response (QR) code. Here, the information about the user may include a name of the user, and the information about the mobile terminal apparatus may include a mobile phone number, and a media access control (MAC) address. However, the exemplary embodiment is not limited thereto.

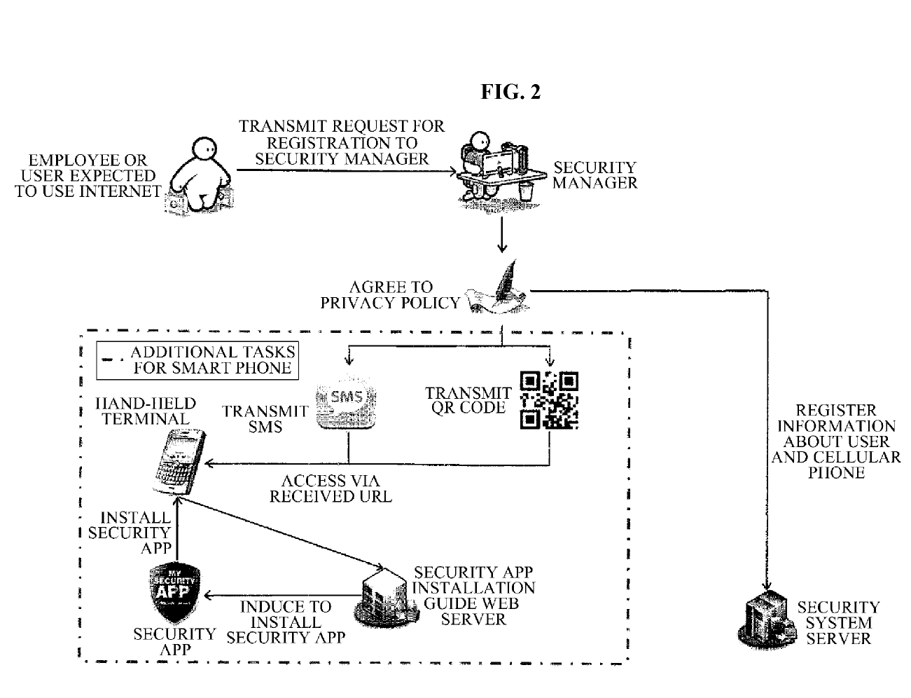

FIG. 2 is a diagram illustrating an advance registration operation. As shown in FIG. 2, the security manager may receive an agreement to a privacy policy from a user expected to use the Internet, and input, into the security system server, personal information, and information about a mobile terminal apparatus, for example, a MAC address, a mobile phone number, and the like. In a case of a smart phone, the security manager may transmit an SMS or a QR code to the mobile terminal apparatus, as necessary, to display a URL of a security app installation guide site, thereby inducing the user to install a security app.

In an exemplary embodiment, the privacy policy agreement operation may be performed by a method of registering the agreement in written form by a security manager transmitting the agreement to the security system server using an SMS, or a method of inputting, by the mobile terminal apparatus, whether the user agrees to a privacy policy, when the security system server transmits an URL or an authentication code to the mobile terminal apparatus using an SMS.

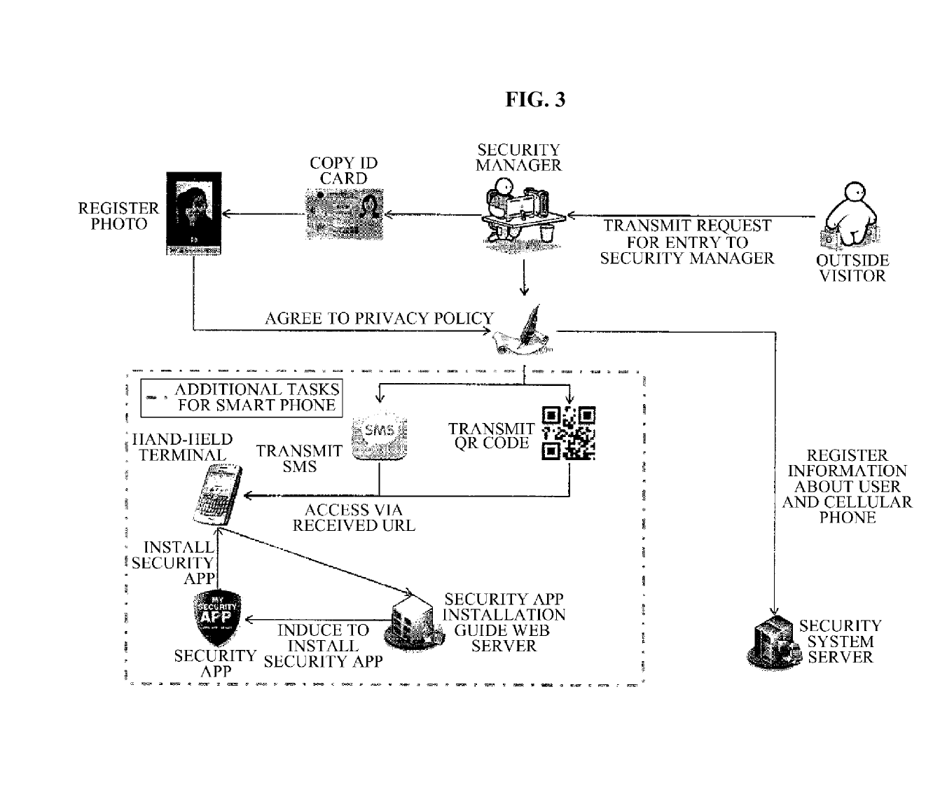

FIG. 3 is a diagram illustrating the privacy policy agreement operation. As shown in FIG. 3, when an unexpected visitor needs to use the Internet, the security manager may perform an identification procedure of copying an identity (ID) card, registering a photo, and the like. When the visitor completes the procedure, the security manger may receive an agreement to the privacy policy from the visitor, and input personal information, and information about the mobile terminal apparatus, for example, a MAC address, a mobile phone number, and the like. In a case of a smart phone, the security manager may transmit an SMS or a QR code to the mobile terminal apparatus, as necessary, to display a URL of a security app installation guide site, thereby inducing the user to install a security app.

In an exemplary embodiment, the blocking application unit may be performed by a method of providing security corresponding to non-work related site blocking, upload restrictions, and Internet blocking by interworking with a subscriber authentication system of a mobile communication provider, when a MAC address, information about a base station, or an identification number of the mobile terminal apparatus for each Internet protocol (IP) address received by the blocking server in real time corresponds to the registered information about the user, and a method of discontinuing the security when the user agrees to collection of an Internet usage history in a case of an exceptional situation in which the user has to use the Internet.

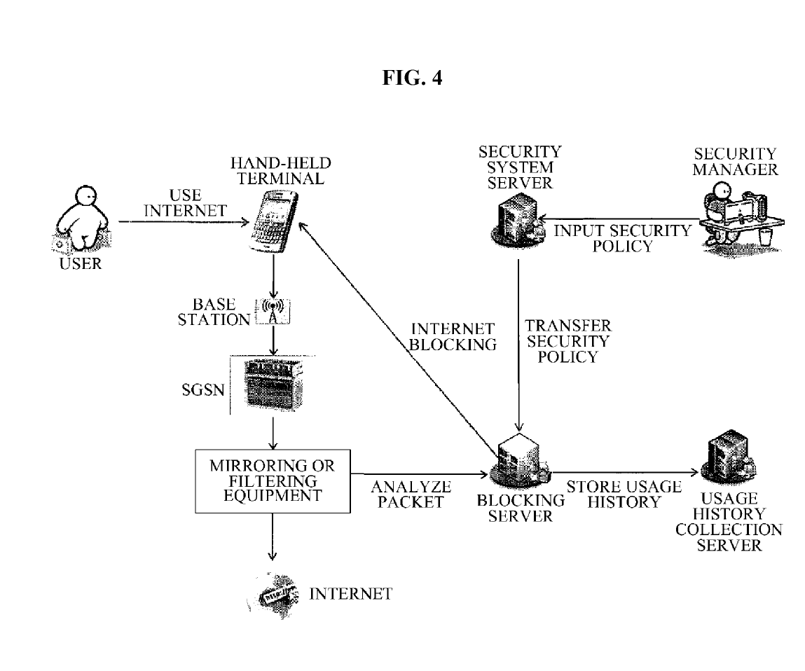

FIG. 4 is a diagram illustrating the blocking application operation for a case in which an app is not yet installed. As shown in FIG. 4, Internet blocking for a mobile terminal apparatus without a security app installed may be performed as follows.

When the user uses the Internet through the mobile terminal apparatus, packets may be concentrated on a serving general packet radio service (GPRS) support node (SGSN) concentration switch through a base station, and transmitted over the Internet. By installing mirroring or filtering equipment between the base station and the blocking server, the input packets may be received by the blocking server. In this example, the blocking server may receive the blocking policy input into the security system server by the security manager. The blocking server may perform Internet blocking, upload restrictions, and non-work related site blocking of the mobile terminal apparatus corresponding to the blocking policy, and transmit and record an Internet usage history in a usage history collection server.

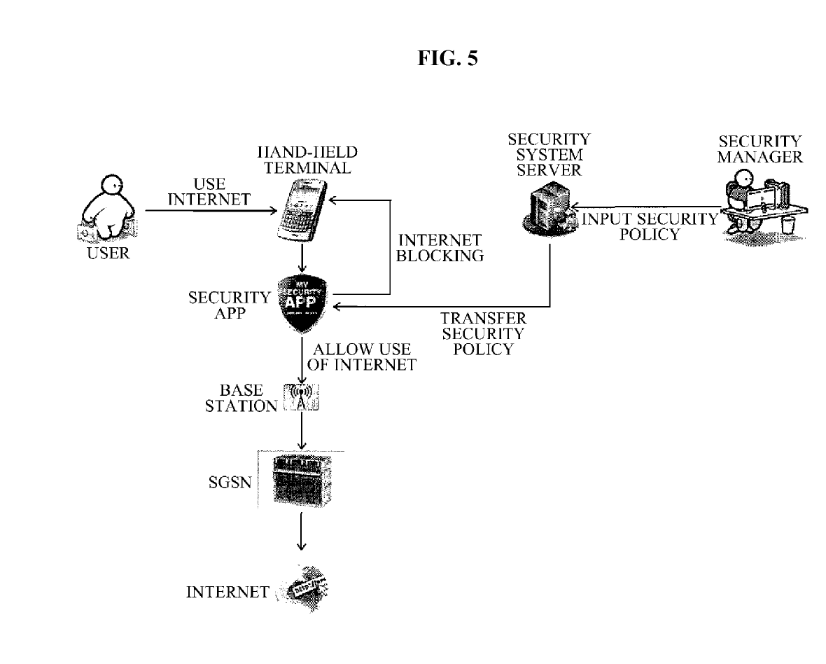

FIG. 5 is a diagram illustrating the blocking application operation for a case in which an app is installed. As shown in FIG. 5, Internet blocking for a mobile terminal apparatus with a security app installed may be performed as follows.

When the user uses the Internet through the mobile terminal apparatus, packets may be concentrated on an SGSN concentration switch via a base station through the security app, and transmitted over the Internet. In this example, the security app may receive the blocking policy input into the security system server by the security manager. The security app may perform Internet blocking, upload restrictions, and non-work related site blocking of the mobile terminal apparatus corresponding to the blocking policy, and transmit and record an Internet usage history in a usage history collection server.

In an exemplary embodiment, the blocking application operation may include identifying, by the blocking server, a target for blocking application, through an IP to be used and an identification number of a mobile terminal apparatus of the target.

In an exemplary embodiment, the blocking application operation may include identifying, by the blocking server, a target for blocking application, through an IP to be used and a MAC address of a mobile terminal apparatus of the target.

In an exemplary embodiment, the blocking application operation may include identifying, by the blocking server, a target for the blocking application, through an app (a security program) installed in a mobile terminal apparatus of the target.

In an exemplary embodiment, the blocking discontinuation operation may be performed by a method of discontinuing blocking by transmitting, by a security manager, a QR code to the security system server or inputting blocking discontinuation information into the security system server, when the mobile terminal apparatus leaves an area (an inside of a workplace) to which the blocking policy applies, or a method of transmitting, to the security system server by the mobile terminal apparatus, information regarding whether blocking is discontinued, and uninstalling a security app and discontinuing blocking, simultaneously, when the mobile terminal apparatus leaves the area to which the blocking policy applies or when the security manager inputs uninstallation information for a case in which the security app is installed.

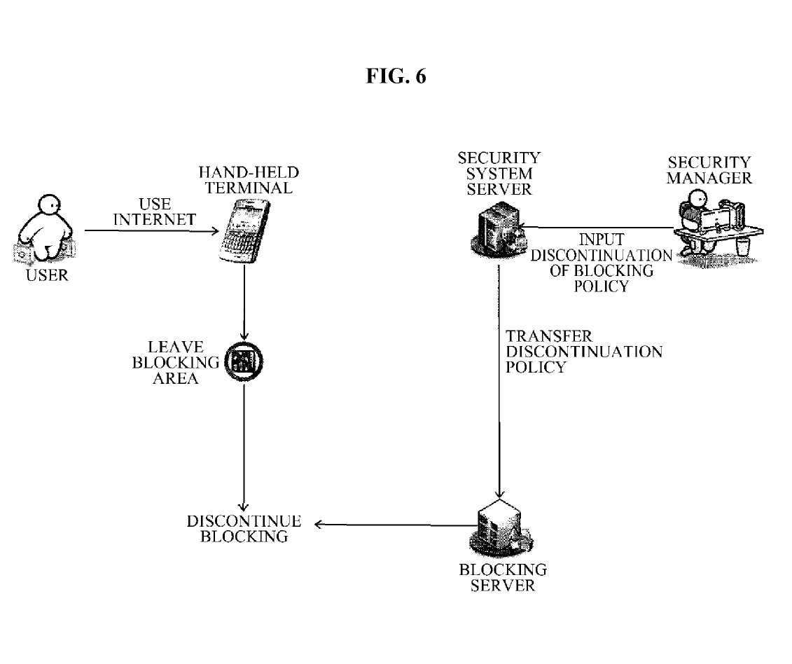

FIG. 6 is a diagram illustrating the blocking discontinuation operation for a case in which an app is not yet installed. As shown in FIG. 6, discontinuation of Internet blocking for a mobile terminal apparatus without a security app installed may be performed as follows.

As an example, when the user having the mobile terminal apparatus leaves an area requiring security, the Internet blocking may be discontinued automatically since the blocking server blocks only a network or a base station in the area. As another example, when the security manager instructs the security system server to discontinue the Internet blocking, a discontinuation policy may be transferred to the blocking server and the Internet blocking may be discontinued in the area requiring security.

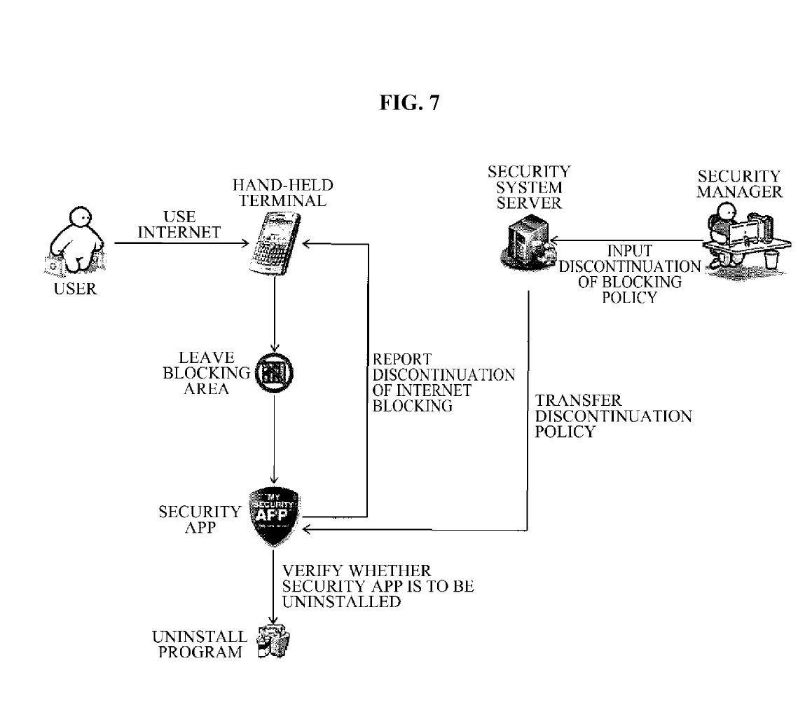

FIG. 7 is a diagram illustrating the blocking discontinuation operation for a case in which an app is installed. As shown in FIG. 7, discontinuation of Internet blocking for a mobile terminal apparatus with a security app installed may be performed as follows.

As an example, when the user having the mobile terminal apparatus leaves an area requiring security, the security app may display, on the mobile terminal apparatus, a window indicating that the Internet is normally available since the mobile terminal application leaves the blocking area. Whether the user wants to uninstall the security app may be verified, and the security app be uninstalled. As another example, when the security manager instructs the security system server to discontinue the Internet blocking, a discontinuation policy may be transferred to the security app to report the discontinuation of the Internet blocking. Whether the user wants to uninstall the security app may be verified, and the security app be uninstalled.

Exemplary embodiments of the present invention have been shown and described with reference to the accompanying drawings.

In addition, the embodiments adopted herein have been described using detailed examples only for ease of description. Changes may be made to these embodiments without departing from the principles and spirit of the invention, the scope of which is defined by the claims and their equivalents.

### INDUSTRIAL APPLICABILITY

According to embodiments of the present invention, a security manager may construct an in-house security system, and apply a security procedure for usage of a mobile terminal apparatus to an outside visitor or an employee visiting a workplace. When the outside visitor or the employee wishes to use the mobile terminal apparatus, an agreement of the user to a privacy policy may be obtained, and personal information, information about a mobile phone, and the like may be recorded with a security system server. In addition, by installing an app in the mobile terminal apparatus, as necessary, limited use of the Internet may be allowed and a corresponding usage history may be recorded. In so doing, it is possible to increase work efficiency by internally protecting in-house confidential information and restricting an access to a non-work related site.

Also, by recording, using a mobile terminal apparatus, a history of Internet usage for an access to a non-work related site, leakage of confidential information, and the like, or by performing upload restrictions, Internet blocking, and the like, it is possible to prevent issues, for example, leakage of important data, decrease in a work efficiency, and the like. It is also possible to produce an effect of tracking a user of a mobile terminal apparatus when the foregoing issues occur.

1. A method of securing a mobile terminal apparatus in a limited area requiring security, such as a workplace, the method comprising:
a basic information registration operation of inputting information about a user and information about a mobile terminal apparatus into a security system server;
a private policy agreement operation of notifying the security system server of information regarding whether an agreement on collection of traffic related to security and Internet blocking is obtained in advance;
a blocking policy transmission operation of transmitting, by the security system server, a blocking policy to a blocking server;
a blocking application operation of allowing or blocking, by the blocking server, an access of the mobile terminal apparatus to the Internet; and
a blocking discontinuation operation of notifying, by the security system server, the mobile terminal apparatus of discontinuation of the blocking policy.

2. The method of claim 1, further comprising:
a packet transmission operation of transmitting, to the blocking server, a packet input into packet mirroring or packet filtering equipment installed between a base station and the blocking server, when the mobile terminal apparatus accesses the Internet through the base station.

3. The method of claim 1, further comprising:
a tunneling operation of tunneling, to the blocking server, a packet used by the mobile terminal apparatus, through software installed in the mobile terminal apparatus to support tunneling, when the mobile terminal apparatus accesses the Internet through a base station.

4. The method of claim 2, wherein the base station comprises a femtocell access point (AP), or a mobile communication base station.

5. The method of claim 1, wherein the basic information registration operation is performed by:
a method of inputting, into the security system server directly by a security manager, the information about the user and the information about the mobile terminal apparatus; or
a method of installing, by the mobile terminal apparatus, a security app (a mobile terminal security program), when the security system server transmits a uniform resource locator (URL) or an authentication code to the mobile terminal apparatus, using a short message service (SMS) or a quick response (QR) code,
wherein the information about the user comprises a name of the user, and the information about the mobile terminal apparatus comprises a mobile phone number, and a media access control (MAC) address.

6. The method of claim 1, wherein the privacy policy agreement operation is performed by:
a method of registering the agreement in written form by a security manager transmitting the agreement to the security system server using an SMS; or
a method of inputting, by the mobile terminal apparatus, whether the user agrees to a privacy policy, when the security system server transmits an URL or an authentication code to the mobile terminal apparatus using an SMS.

7. The method of claim 1, wherein the blocking application operation is performed by:
a method of providing security corresponding to non-work related site blocking, upload restrictions, and Internet blocking by interworking with a subscriber authentication system of a mobile communication provider, when a MAC address, information about a base station, or an identification number of the mobile terminal apparatus for each Internet protocol (IP) address received by the blocking server in real time corresponds to the registered information about the user; and
a method of discontinuing the security when the user agrees to collection of an Internet usage history in a case of an exceptional situation in which the user has to use the Internet.

8. The method of claim 1, wherein the blocking application operation comprises identifying, by the blocking server, a target for blocking application, through an IP to be used and an identification number of a mobile terminal apparatus of the target.

9. The method of claim 1, wherein the blocking application operation comprises identifying, by the blocking server, a target for blocking application, through an IP to be used and a MAC address of a mobile terminal apparatus of the target.

10. The method of claim 1, wherein the blocking application operation comprises identifying, by the blocking server, a target for blocking application, through an app (a security program) installed in a mobile terminal apparatus of the target.

11. The method of claim 1, wherein the blocking discontinuation operation is performed by:
a method of discontinuing blocking by transmitting, by a security manager, a QR code to the security system server or inputting blocking discontinuation information into the security system server, when the mobile terminal apparatus leaves an area (inside of a workplace) to which the blocking policy applies; or
a method of transmitting, to the security system server by the mobile terminal apparatus, information regarding whether blocking is discontinued, and uninstalling a security app and discontinuing blocking, simultaneously, when the mobile terminal apparatus leaves the area to which the blocking policy applies or when the security manager inputs uninstallation information for a case in which the security app is installed.
